(19) United States
(12) Patent Application Publication
(10) Pub. No.: US 2005/0157315 A1
(43) Pub. Date: Jul. 21, 2005

(54) Print control apparatus, control method therefor, and program for implementing the method

(75) Inventor: Kazunori Kato, Kawasaki-shi (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 11/038,953

(22) Filed: Jan. 19, 2005

(30) Foreign Application Priority Data
Jan. 19, 2004 (JP) 2004-011229

(51) Int. Cl. G06F 15/00

(52) U.S. Cl. 358/1.1; 358/1.13

(57) ABSTRACT

A print control apparatus which can prevent a user from being aware of a printed output product preparing process being not fully automated, and enable a print service provider to properly discriminate between automated processes and unautomated processes and also enable a user who actually performs a print process to complete a printed output product as intended without mistakes. A host computer 101 supplies a print job to a printer 102 capable of performing finishing processing on a printed output product. The host computer 101 receives an electronic original including setting items related to printing and finishing of predetermined document data. When the received electronic original is comprised of a plurality of document data files, it is determined which of setting items related to processes which are not permitted to be set in printing each of the document data files, from among the setting items contained in the electronic original.

### BACKGROUND OF THE INVENTION

1. Field of the Invention

The present invention relates to a print control apparatus, a control method therefor, and a program for implementing the method, and more particularly to a print control apparatus, a control method therefor, and a program for implementing the method, which are suitable for use in externally carrying out finishing settings, such as print format settings and bookbinding finishing settings, for an electronic document to be printed, and causing a printing apparatus, such as a printer or a copying machine having a printer function, to execute printing.

2. Description of the Related Art

Conventionally, a print service system is known in which a print request is sent to a print service center via the Internet.

Further, as a conventional example of this kind, a printing system utilizing the above print service system has been proposed in which WEB-based sending of originals is carried out via a client computer. In this proposed printing system, first, a client computer can designate various settings related to an output sheet size, stapling, a desired output print distribution date, and so forth, and designate a place of a file to be printed out. Thereafter, the client computer uploads the designated file to a WWW server to make a print request (see e.g. Japanese Laid-Open Patent Publication (Kokai) No. 2001-312381).

On the other hand, there has conventionally been proposed a technique related to a user interface, in which items contained in a print setup screen displayed on a client computer are provided by a service provider so that a user intending to make a print request can set the above-mentioned settings. The user who makes a print request can use the interface to designate desired ones of the items provided by the service provider (see e.g. Japanese Laid-Open Patent Publication (Kokai) No. 2002-171381).

The items provided to the user by the service provider include items related to sheet size and bookbinding operation, such as stapling, punching, case binding, double leave, and so forth. Conventionally proposed techniques related to bookbinding includes a method of applying bookbinding methods, such as twofold bookbinding, ring binding, and paste binding, to printed output products automatically or manually, using bookbinding machines (see e.g. Japanese Laid-Open Patent Publication (Kokai) No. 2002-297579).

Actually, however, in many cases, it is unrealistic that a process for preparing output products is fully automatically carried out by a print service provider, and in actuality, a service operator is involved in carrying out the process. Further, the process for preparing output products is sometimes a mixture of two types of processes: automatic processes in which processing for preparation of output products is automatically carried out and manual processes in which processing for the same is manually carried out by a service operator. However, it is desirable that a print request screen which is readily understandable should be provided for the user. Needless to say, when the two types of processes are mixed, it is desirable that the print service provider should prevent the service operator from being aware of the printed output product preparing process is comprised of automatically carried out processes and manually carried out processes existing in a mixed state.

### SUMMARY OF THE INVENTION

It is an object of the present invention to provide a print control apparatus, a control method therefor, and a program for implementing the method, which can prevent a user from being aware of a printed output product preparing process being not fully automated, and enable a print service provider to properly discriminate between automated processes and unautomated processes and also enable a user who actually performs a print process to complete a printed output product as intended without mistakes.

To attain the above object, in a first aspect of the present invention, there is provide a print control apparatus that supplies a print job to a printing apparatus capable of performing finishing processing on a printed output product, comprising an original receiving device that receives an electronic original containing instructions related to printing and finishing of predetermined document data, and a presenting device that distinguishably presents processes which are unexecutable in executing the print job and processes which are executable, from among processes corresponding to the instructions contained in the electronic original, based on contents of the electronic original.

Preferably, the presenting device is operable when the electronic original comprises a plurality of document data files, to distinguishably present the processes which are unexecutable in executing the print job, from among the processes corresponding to the instructions contained in the electronic original.

To attain the above object, in a second aspect of the present invention, there is provided a print control apparatus that supplies a print job to a printing apparatus capable of performing finishing processing on a printed output product, comprising an original receiving device that receives an electronic original containing instructions related to printing and finishing of predetermined document data, a determination device that is operable when the electronic original received by the original receiving device comprises a plurality of document data files, to determine which of setting items related to processes which are not permitted to be set in printing each of the document data files, from among setting items related to processes corresponding to the instructions contained in the electronic original, a changing device that changes default print settings of the printing apparatus to settings matching setting items obtained by excluding the setting items determined not permitted to be set from the setting items related to the processes corresponding to the instructions contained in the electronic original, and an issuing device that issues the print job in accordance with the print settings changed by the changing device.

Preferably, the print control apparatus comprises a storage device that retrievably stores the setting items not permitted to be set, and a presenting device that presents the setting items not permitted to be set.

To attain the above object, in a third aspect of the present invention, there is provided a method of controlling a print control apparatus that supplies a print job to a printing apparatus capable of performing finishing processing on a printed output product, comprising an original receiving step of receiving an electronic original containing instructions related to printing and finishing of predetermined document data, and a presenting step of distinguishably presenting processes which are unexecutable in executing the print job and processes which are executable, from among processes corresponding to the instructions contained in the electronic original, based on contents of the electronic original.

Preferably, when the electronic original comprises a plurality of document data files, in the presenting step, the processes which are unexecutable in executing the print job are distinguishably presented, from among the processes corresponding to the instructions contained in the electronic original.

To attain the above object, in a fourth aspect of the present invention, there is provided a method of controlling a print control apparatus that supplies a print job to a printing apparatus capable of performing finishing processing on a printed output product, comprising an original receiving step of receiving an electronic original containing instructions related to printing and finishing of predetermined document data, a determination step of determining which of setting items related to processes which are not permitted to be set in printing each of a plurality of document data files, from among setting items related to processes corresponding to the instructions contained in the electronic original, when the electronic original received in the original receiving step comprises the plurality of document data files, a changing step of changing default print settings of the printing apparatus to settings matching setting items obtained by excluding the setting items determined not permitted to be set from the setting items related to the processes corresponding to the instructions contained in the electronic original, and an issuing step of issuing the print job in accordance with the print settings changed in the changing step.

Preferably, the method comprises a storage step of retrievably storing the setting items not permitted to be set, and a presenting step of presenting the setting items not permitted to be set.

To attain the above object, in a fifth aspect of the present invention, there is provided a program for causing a computer to execute a method of controlling a print control apparatus that supplies a print job to a printing apparatus capable of performing finishing processing on a printed output product, comprising an original receiving module for receiving an electronic original containing instructions related to printing and finishing of predetermined document data, and a presenting module for distinguishably presenting processes which are unexecutable in executing the print job and processes which are executable, from among processes corresponding to the instructions contained in the electronic original, based on contents of the electronic original.

Preferably, when the electronic original comprises a plurality of document data files, the presenting distinguishably presents the processes which are unexecutable in executing the print job, from among the processes corresponding to the instructions contained in the electronic original.

To attain the above object, in a sixth aspect of the present invention, there is provided a program for causing a computer to execute a method of controlling a print control apparatus that supplies a print job to a printing apparatus capable of performing finishing processing on a printed output product, comprising an original receiving module for receiving an electronic original containing instructions related to printing and finishing of predetermined document data, a determination module for determining which of setting items related to processes which are not permitted to be set in printing each of a plurality of document data files, from among setting items related to processes corresponding to the instructions contained in the electronic original, when the electronic original received by the original receiving module comprises the plurality of document data files, a changing module for changing default print settings of the printing apparatus to settings matching setting items obtained by excluding the setting items determined not permitted to be set from the setting items related to the processes corresponding to the instructions contained in the electronic original, and an issuing module for issuing the print job in accordance with the print settings changed by the changing module.

Preferably, the setting items related to the processes corresponding to the instructions contained in the electronic original are for setting a print format in which the document data is printed on a printing medium and a book finishing method applied in executing a bookbinding process after printing.

Preferably, the program comprises a storage module for retrievably storing the setting items not permitted to be set, and a presenting module for presenting the setting items not permitted to be set.

The above and other objects, features, and advantages of the present invention will become more apparent from the following detailed description taken in conjunction with the accompanying drawings.

### BRIEF DESCRIPTION OF THE DRAWINGS

FIG. 1 is a block diagram schematically showing the arrangement of a printing system including a print control apparatus according to a first embodiment of the present invention;

FIG. 2 is a schematic block diagram showing the configuration of a host computer on a pint service providing side appearing in FIG. 1;

FIG. 3 is a schematic block diagram showing the configuration of a printer on the pint service providing side;

FIG. 4 is a diagram useful in explaining the internal configuration of a host computer on a print requesting side appearing in FIG. 1 and the flow of a print settings-instructing process;

FIG. 5 is a diagram useful in explaining the internal configuration of the pint service providing side host computer and the flow of a printing process;

FIG. 6 is a diagram useful in explaining the software configuration of a host computer on a pint service providing side and the flow of a printing process, according to a second embodiment of the present invention;

FIG. 7 is a view of a print document data designation screen displayed on a display section of the print requesting side host computer in FIG. 4;

FIG. 8 is a view of a print format and bookbinding finishing-designating screen displayed on the display section of the print requesting side host computer in FIG. 4;

FIG. 9 is a view of a print settings and print document display screen displayed on a display section of the pint service providing side host computer in FIG. 5;

FIG. 10 is a view of a print settings dialog screen displayed on the display section of the pint service providing side host computer in FIG. 5;

FIG. 11 is a diagram showing the conflict relationship between bookbinding finishing setting items and printing of a plurality of print document files, which is stored in a print settings conflict database in FIG. 5; and

FIG. 12 is a diagram useful in explaining a default print settings-changing method executed by a default print settings-providing section and a print command-issuing method executed by the application print section appearing in FIG. 5.

### DETAILED DESCRIPTION OF THE PREFERRED EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

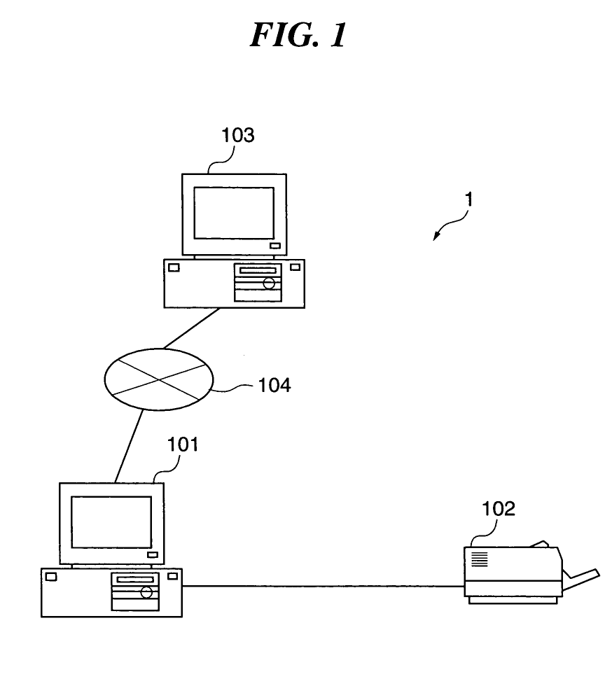

FIG. 1 is a block diagram schematically showing the arrangement of a printing system including a print control apparatus according to a first embodiment of the present invention.

In the present printing system, it is assumed, by way of example, that a host computer 101 and a printer 102 are a print service-providing side, and a host computer 103 is a client computer used by a user who requests a print service, but actually, this is merely an example and not limitative.

As shown in FIG. 1, the host computer 101 as an information processing apparatus and the printer 102 as a printing apparatus are connected to the host computer 101 via a parallel cable, not shown, or a network cable, not shown, such as an Ethernet (registered trademark) cable, for communication with each other, and a computer 103 is connected to the host computer 101 via a communication line 104, such as a LAN or the Internet, for communication therewith. Although in FIG. 1, each of the computers 101 and 103 and the printer 102 is shown as a single apparatus, the printing system 1 may be comprised of a plurality of computers 101 and 103 and a plurality of printers 102.

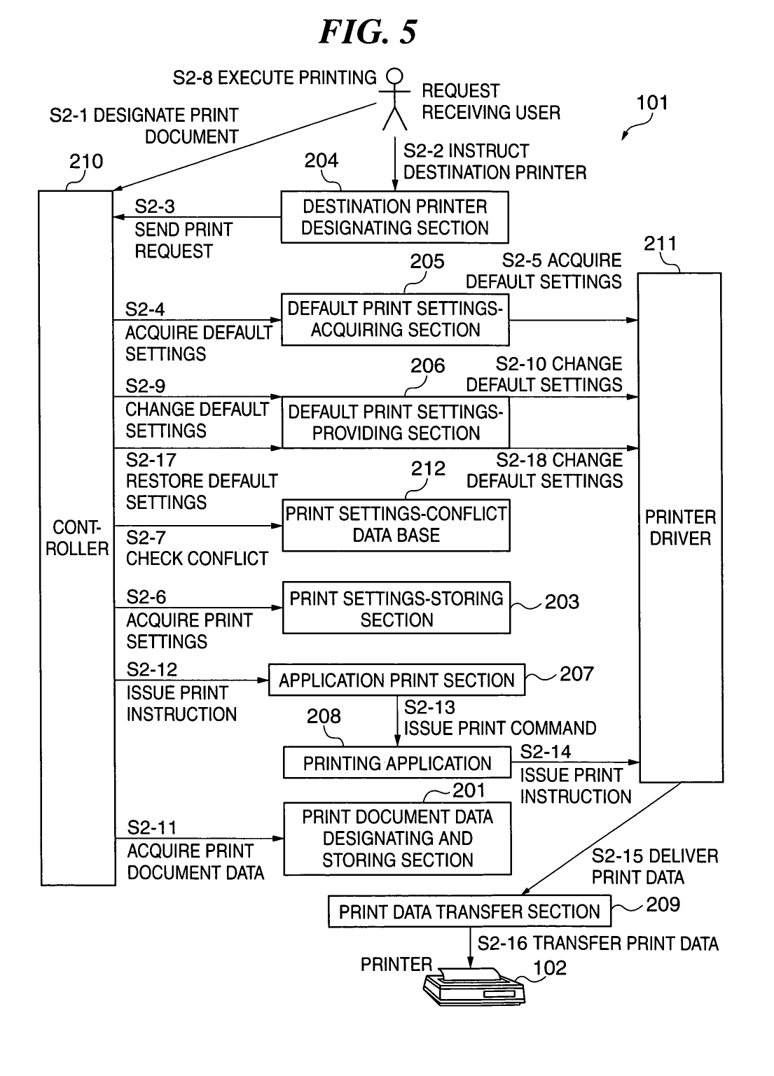

The host computer 101, which is capable of executing various programs including application programs, incorporates a printer driver (see FIG. 5) having the function of converting document data, including text and images, into print data (printer language) processable by the printer 102. The print data is PDL (Page Description Language) data, for example. The printer driver supports a plurality of printer drivers.

The printer 102 is connected to the host computer 101 via a parallel cable, not shown, or a network interface, not shown, or connected to a network to which the host computer 101 is connected, via a network interface, not shown. The printer 102 has the function of analyzing a print job including print data sent from the host computer 101, converting the print data into page-by-page dot images, and printing the dot images on a page-by-page basis. The printer 102 can be implemented by any of printers employing different printing methods, such as a laser beam printer employing an electrophotographic printing method, an ink jet printer employing an ink jet printing method, and a thermal transfer printer employing a thermal transfer printing method.

Further, in FIG. 1, the print service providing side comprised of the host computer 101 and the printer 102 is also provided with an apparatus (bookbinding machine), not shown, for performing bookbinding operations including stapling, punching, case binding, double leave, and so forth, which enables bookbinding methods, such as twofold bookbinding, ring binding, and paste binding, to be applied to printed output products automatically or manually using the bookbinding machine. Whether a bookbinding operation is to be performed automatically or manually depends on the conditions of the print service providing side.

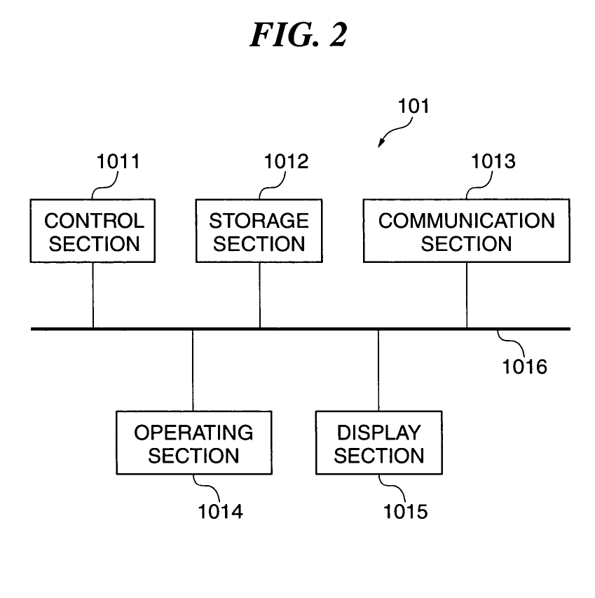

FIG. 2 is a schematic block diagram showing the configuration of the pint service providing side host computer 101 appearing in FIG. 1.

As shown in FIG. 2, similarly to an information processing apparatus in general, the host computer 101 is comprised of a control section 1011, a storage section 1012, a communication section 1013, an operating section 1014, a display section 1015 (presentation device), and a system bus 1016.

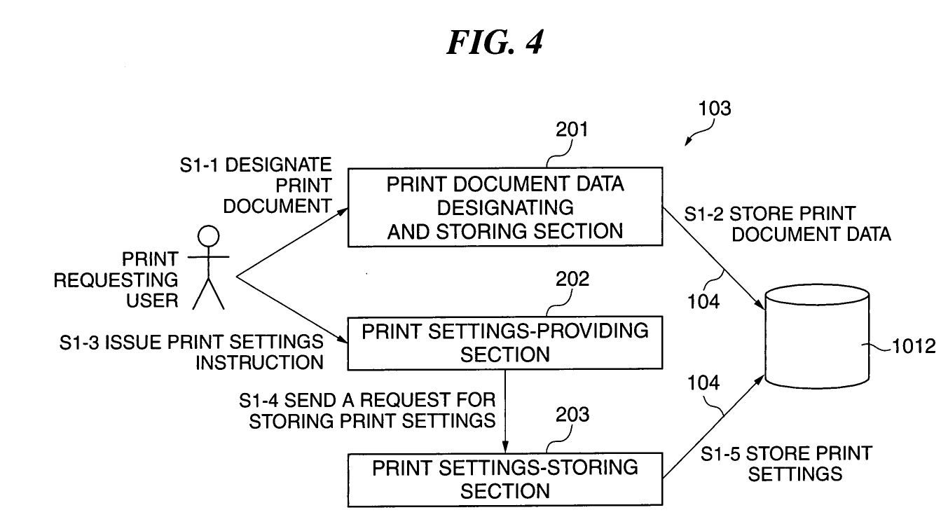

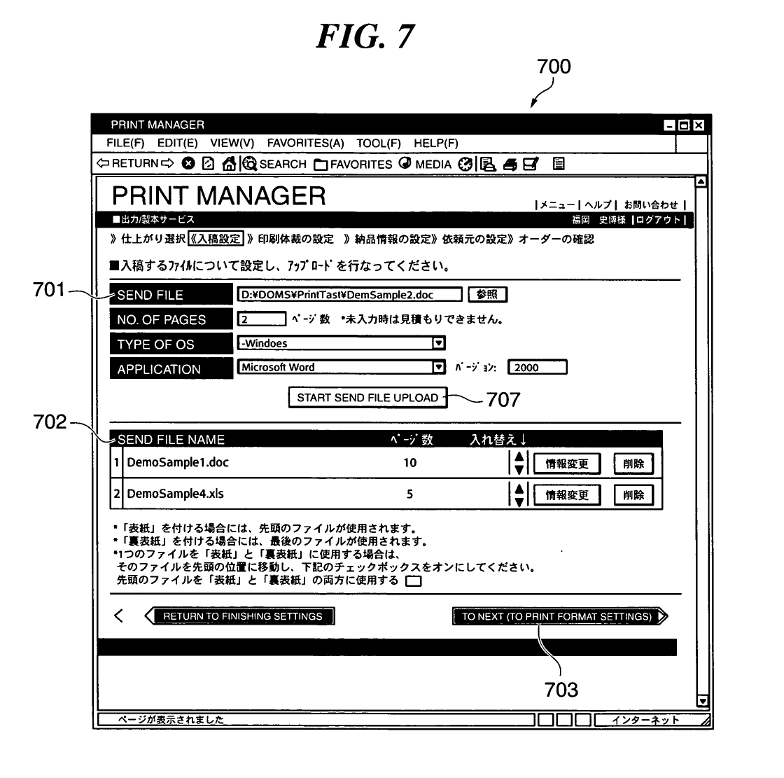

The control section 1011 controls the overall operation of the host computer 101 via the system bus 1016, and executes processes shown in FIGS. 4, 5, 6, and 12, described in detail hereinafter, based on programs stored in the storage section 1012. The control section 1011 includes a controller 210 appearing in FIG. 5. The storage section 1012 includes a ROM that stores the programs for executing the processes shown in FIGS. 4, 5, 6, and 12, and programs for causing the display section 1015 to display user interfaces shown in FIGS. 7, 8, 9, and 10, described in detail hereinafter, a RAM that serves as a work area and a temporary storage area, and databases, such as a print settings conflict database 212. In FIG. 2, the ROM, the RAM, and the databases are shown as the storage section 1012 by a single block for simplicity.

The communication section 1013 performs the function of sending and receiving various kinds of data to and from the printer 102, i.e. communications with the printer 102, and includes a print data transfer section 209 appearing in FIG. 5. The operating section 1014 is operated by a user so as to enter various kinds of data and give various instructions. The operating section 1014 is comprised of a keyboard and a pointing device. The input of the instructions using the operating section 1014 is performed via the user interfaces shown in FIGS. 7, 8, 9, and 10. The input instructions are transmitted to the control section 1011, and the host computers 101 and 103 execute various processes in response to the respective corresponding instructions.

The display section 1015 displays setup screens and the like via which various settings are performed for causing the printer 102 to execute printing. The display section 1015 is comprised of a CRT display or a liquid crystal display. User interfaces described in detail hereinafter with reference to FIGS. 7, 8, 9 and 10 are provided by predetermined screens displayed on the display section 1015 in response to drawing instructions (display control) from the control section 1011.

The host computer 103 has the same configuration as that of the host computer 101 described above. Therefore, component elements corresponding to those of the host computer 101 are designated by identical reference numerals.

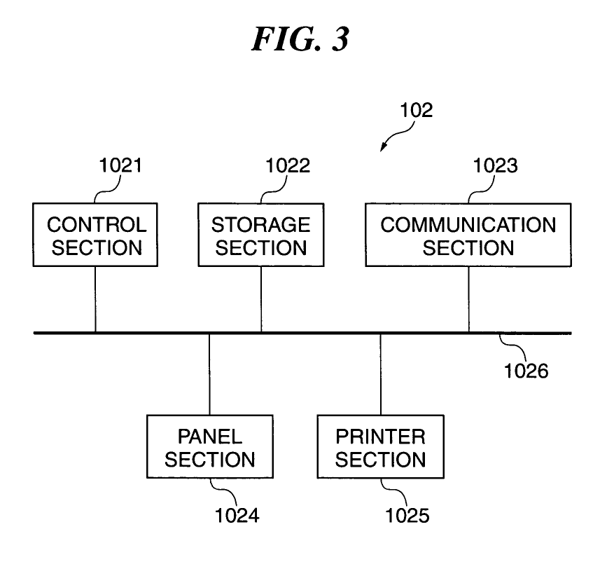

FIG. 3 is a block diagram schematically showing the configuration of the printer 102.

As shown in FIG. 3, the printer 102 is comprised of a control section 1021, a storage section 1022, a communication section 1023, a panel section 1024, a printer section 1025, and a system bus 1026.

The control section 1021 controls the overall operation of the printer 102 via the system bus 1026 to execute processing e.g. for converting print data received from the host computer 101 into dot images. The conversion of print data into dot images also includes a case of converting PDL data into intermediate data such as a display list, and then converting the resulting intermediate data into dot image data. The storage section 1022 includes a ROM that stores programs and a RAM that serves as a work area and a temporary storage area. In FIG. 3, the ROM, the RAM, and so forth are shown as the storage section 1022 by a single block for simplicity.

The communication section 1023 performs processing for communication of various kinds of data with the host computer 101. The panel section 1024 is provided with a display section that displays various buttons including one for use in turning on/off a power supply, a status of the printer 102, and so forth. The printer section 1025 performs printing operation for forming an image on a printing medium. When the electrophotographic printing method is employed, for example, the printer section 1025 includes a laser light emitting section, a photosensitive drum, an electrostatic charger, a developing device, and a transfer device.

FIG. 7 is a view showing a print document data designation screen displayed on a display section 1015 of the print requesting side host computer 103 in FIG. 4.

When the print document data designation screen 700 is displayed on the display section 1015 of the host computer 103, a user who is to send a print request to the print service providing side (hereinafter simply referred to as “the print requesting user”) can designate a plurality of files for output product preparation request by designating print documents desired to be printed and finished, via a send file (electronic original) designating field 701, and depressing a “send file upload start” button. At this time, a list of the designated document files is displayed in a send file name list 702 in FIG. 7. The number of document data files that can be registered in the list is not limited to two, but only one document data file or more than two may be registered.

In a note display area 704, there are displayed notes to the effect that a front cover, the body of document data, and a back cover can be designated as different files, and by default, the host computer 103 recognizes a leading document file in the send file name list 702 as a front cover, and a final file in the same as a back cover.

Further, in a note display area 705, there is displayed a note to the effect that in the case of setting a single file in the send file name list 702 for both a front cover and a back cover, a user has only to move the file to the top of the send file name list 702, and then check a check field 706.

When the host computer 103 informs the host computer 101 of the setting of the front and back covers designated by the user (not by default) as above, the host computer 101 generates print data to be delivered to the printer, such that the leading file in the send file name list 702 should be printed as both the front cover and the back cover.

It is to be understood that document data in the present embodiment may be a document file generated via word processing software, an image file generated using a digital camera, or a drawn graphics file generated via graphics drawing software. In short, the present embodiment is applicable to any data file in a printable form.

A single document file or a plurality of document files designated via the print document data designation screen 700 shown as the user interface in FIG. 7 are sent from the host computer 103 to a print document data designating and storing section 201 (see FIG. 5) provided in the host computer 101.

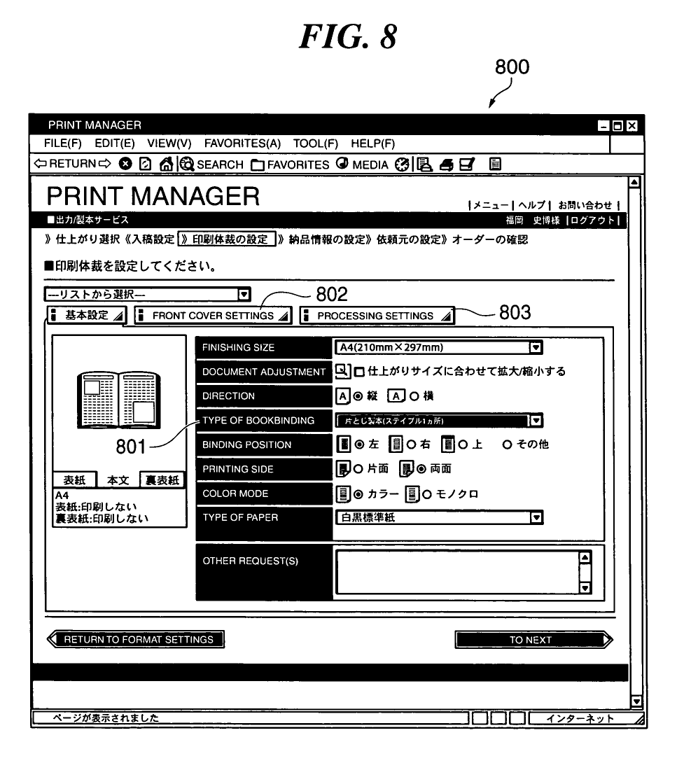

When a “Next (to Print Format Setting)” button 703 in FIG. 7 is depressed by the user using the pointing device or the like, a print format and bookbinding finishing-designating screen 800 is displayed on a display section 1015 of the host computer 103 to provide a user interface, as shown in FIG. 8.

FIG. 8 is a view showing a print format and bookbinding finishing-designating screen displayed on the display section 1015 of the print requesting side host computer 103 in FIG. 4.

In FIG. 8, the print format and bookbinding finishing-designating screen 800 provides the user interface which allows the user to designate various finishing processes to be performed on a printed output product. The user uses the screen 800 to specify a print format for a print document designated via the print document data designation screen 700. Print settings include a print format setting for designating a print size, single-sided/double-sided printing, and so forth, and a bookbinding finishing setting for designating stapling, saddle stitching, and so forth. For example, a binding type-designating field 801 in FIG. 8 is for the user to selectively display a plurality of types of binding, and in the illustrated example, “single stitching (one-position stapling)” is designated. Details of instructions set for specifying the print format via the screen in FIG. 8 are temporarily stored in a print settings storing section 203, described hereinafter with reference to FIG. 4, of the host computer 103, and then stored via the communication line 104 in a print settings storing section 203 provided in the host computer 101 for acquiring print settings of an electronic original and storing the same.

The one or more document files designated via the screen in FIG. 7, and the instruction data, including the print format and bookbinding finishing settings designated via the screen in FIG. 8, are stored in a manner associated with each other. Further, the print settings storing section 203 additionally stores print document information on the document files, the number of the files, and the order of the files, as additional information. The host computer 101 analyzes the additional information to thereby determine whether or not a plurality of document files are designated.

FIG. 4 is a diagram useful in explaining the internal configuration of the print requesting side host computer 103 and the flow of a print settings-instructing process.

As shown in FIG. 4, the host computer 103 is provided with the print document data designating and storing section 201, a print settings-providing section 202, and the print settings-storing section 203.

On the other hand, FIG. 5 is a diagram useful in explaining the internal configuration of the print service providing side host computer 101 and the flow of a printing process.

As shown in FIG. 5, the host computer 101 is provided with the print document data designating and storing section 201, the print settings-storing section 203, a destination printer designating section 204, a default print settings-acquiring section 205, a default print settings-providing section 206 (changing device), an application print section 207 (issuing device), a printing application 208, the print data transfer section 209, the controller 210 (determination device), the printer driver 211, and the print settings conflict database 212 (storage device).

First, the internal configuration of the host computer 103 and the flow of the print settings-instructing process will be described in detail with reference to FIG. 4.

The print document data designating and storing section 201 receives a designation of document data in the host computer 103 via the user interfaces described hereinbefore with reference to FIGS. 7 and 8, and outputs the designated document data stored in the host computer 103 to the storage section 1012 of the host computer 101 via the communication line 104.

The print settings-providing section 202 receives instructions for print format and bookbinding finishing settings via the user interface in FIG. 8, and requests the print settings-storing section 203 to store the settings.

The print settings-storing section 203 outputs the print format and bookbinding finishing settings corresponding to the instructions to the storage section 1012 of the host computer 101 via the communication line 104. To connect the print settings-storing section 203 of the host computer 103 to the storage section 1012 of the host computer 101 via the communication line 104, the print settings-storing section 203 is provided with the same function as that of the communication section 1013 appearing in FIG. 2.

Next, the internal configuration of the host computer 101 and the flow of the printing process will be described in detail with reference to FIG. 5.

The destination printer designating section 204 receives a designation of a destination printer from the user, such as an operator receiving a print request (hereinafter simply referred to as “the request receiving user”), and sends the designation to the controller 210.

The default print settings-acquiring section 205 acquires the default print settings of the destination printer from the printer driver 211. The default print settings-providing section 206 changes default print format and bookbinding finishing setting for the printer driver 211. The application print section 207 starts a printing application 208 associated with the designated print document data and issues a print command to the destination printer. The printing application 208 instructs the printer driver 211 to execute printing, via a graphic engine of the operating system.

The controller 210 performs issuing of a default print settings-acquiring request for the default print settings-acquiring section 205. The printer driver 211 converts image data for which a print drawing command is issued from the printing application 208, into PDL data. The print settings conflict database 212 retrievably stores setting items (print format and bookbinding finishing settings) which are not permitted to be set in printing each document data file when a single bound book is to be produced from a plurality of document data files. When received document data consists of a plurality of files, among processes corresponding to instructions related to finishing, processes which are unexecutable in executing a print job can be distinguishably presented based on the print settings conflict database 212. The print data transfer section 209 transfers the PDL data to the destination printer.

Although in the present embodiment, a case where the sections shown in FIG. 4 and those in FIG. 5 exist on the respective different computers is given by way of example, this is not limitative, but modules corresponding to the sections in FIGS. 4 and 5 may exist on the same computer.

Next, a description will be given of the print settings-instructing process and the printing process executed by the printing system of the present embodiment with reference to FIGS. 4 and 5.

Referring first to FIG. 4, the print requesting user operates the operating section 1014 to designate a document to be printed, and the print document data designating and storing section 201 of the host computer 103 receives the designation (step S1-1). The input and output functions performed via the user interface in FIG. 7 corresponds to the print document data designating and storing section 201.

Then, the data of the document is stored in the storage section 1012 provided in the host computer 101 (step S1-2). The storage section 1012 corresponds to the print document data designating and storing section 201 of the host computer 101.

The print settings-providing section 202 receives an instruction as to a print format for the document designated in the step S1-1, given through the operation of the operating section 1014 by the print requesting user (step S1-3) and requests the print settings-storing section 203 to store the instruction information as to the settings of printing (print settings instruction information) (step S1-4). The input and output functions performed via the user interface in FIG. 7 corresponds to the print settings-providing section 202.

The print settings-storing section 203 temporarily stores the print settings instruction information received from the print settings-providing section 202, and then stores the same in the storage section 1012 provided in the host computer 101 (step S1-5) so as to prepare for an information acquisition request. The storage section 1012 corresponds to the print settings-storing section 203 of the host computer 101.

Referring to FIG. 5, first, the controller 210 lists (displays) documents registered in the storage section 1012 by the print document data designating and storing section 201, on the display screen 1015 and the request receiving user operates the operating section 1014 to designate a document selected from the listed documents for the controller 210 (step S2-1).

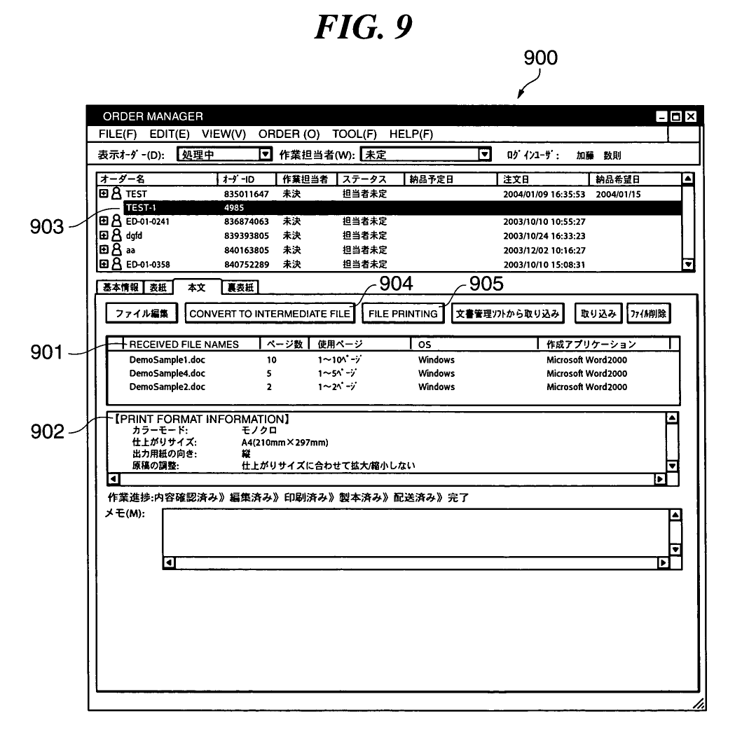

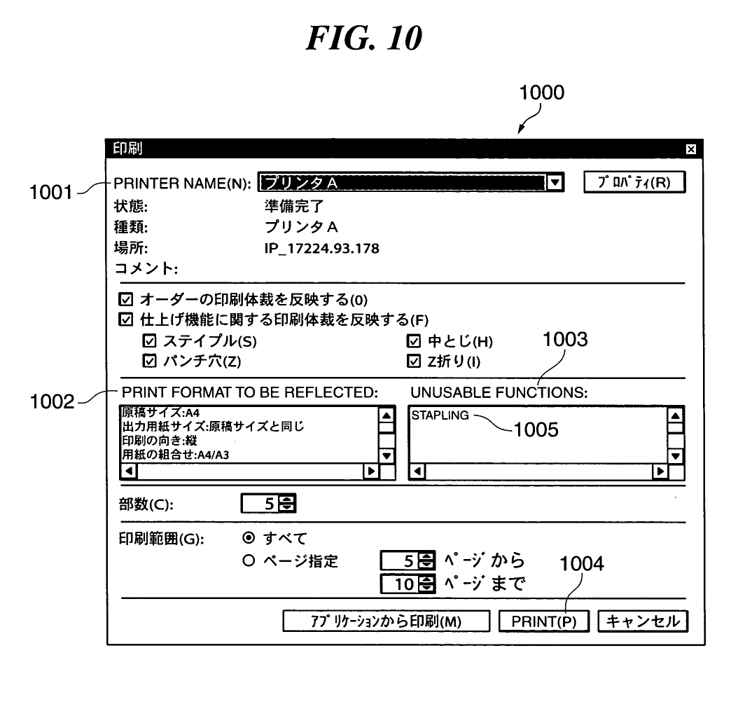

FIG. 9 shows the print settings and print document display screen 900, on which a plurality of documents designated by the request receiving user and print settings designated for the documents are displayed as a list. The request receiving user selects a print document file from the displayed list of documents and depresses a “File Printing” button 905 to thereby give an instruction for printing. When the instruction is given, the destination printer designating section 204 displays a print settings dialog screen shown in FIG. 10.

Then, the destination printer designating section 204 lists (displays) available printers on the display section 1015 to present them to the request receiving user. The request receiving user selects a destination printer from the listed printers by operating the operating section 1014, to give a print instruction (step S2-2).

FIG. 10 shows a print settings dialog screen 1000 in which reference numeral 1001 designates a display field for the destination printer.

When receiving the print instruction from the request receiving user, the destination printer designating section 204 sends a printing printer selecting instruction to the controller 210 (step S2-3).

When receiving the printing printer selecting instruction, first, the controller 210 issues a request for acquiring the default print settings of the destination printer to the default print settings-acquiring section 205 (step S2-4). In response to the request, the default print settings-acquiring section 205 acquires the default print settings of the destination printer from the printer driver 211 (step S2-5) and sends the same to the controller 210. To achieve this process, a method can be envisaged in which a DEVMODE structure containing default values of the printer is acquired via the Windows (registered trademark) GDI (Graphics Device Interface). Then, the controller 210 acquires the print settings instruction information designated in advance in the steps S1-3 to S1-5 in FIG. 4 from the print settings-storing section 203 (step S2-6).

The controller 210 analyzes information appended to the acquired print settings instruction information contained in the received electronic original. When it is judged that a plurality of designated document data files are present in the print document data designating and storing section 201, the controller 210 searches the print settings conflict database 212 to retrieve setting items which are not permitted to be set in printing each document data file when a plurality of document data files are received.

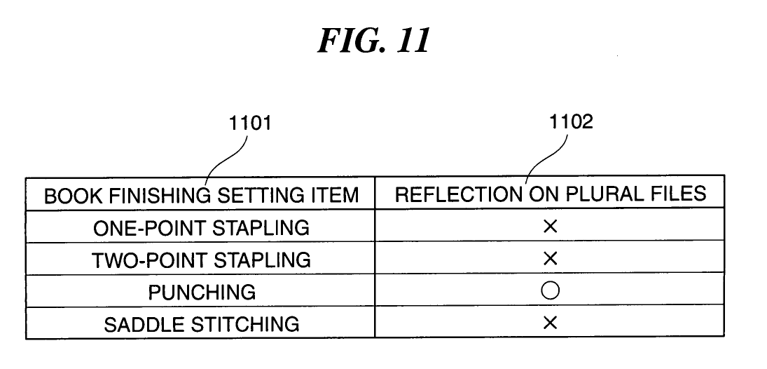

FIG. 11 is a diagram showing the conflict relationship between bookbinding finishing setting items and printing of a plurality of print document files, which is stored in the print settings conflict database 212. When there are a plurality of document data files to be printed, it is determined from the relations shown in FIG. 11, which of designated setting items are not permitted to be set in printing each document data file, and the default print settings of the printing apparatus are changed to match setting items left after excluding the unsettable setting items from the designated setting items, and thereafter a print command is issued to the printing apparatus according to the changed print settings. Therefore, it is possible to eliminate the inconvenience that processes unsuited for production of a single bound book from a plurality of documents are executed. In other words, processes can be executed, which is suited for production of a single bound book from a plurality of documents.

More specifically, FIG. 11 shows that when a plurality of print document files are designated, “one-point stapling”, “two-point stapling”, and “saddle stitching” among the bookbinding finishing setting items cause a conflict, and hence reflection of these items on printing is inhibited. On the other hand, “punching” does not cause a conflict even when a plurality of print document files are designated, and hence reflection of this item on printing is permitted.

Based on this conflict relationship diagram, a searched is carried out, and print setting items that cause a conflict are deleted from the print format and bookbinding finishing setting information, whereby the number of setting items is reduced. After reducing the number of setting items, items to be reflected on the print settings are displayed in a field 1002 in FIG. 10, and items not to be reflected on the print settings are displayed in a field 1003. In the illustrated example, stapling is displayed as an item that causes a conflict, as shown in an entry field 1005 in FIG. 10. This enables the request receiving user to recognize operations to be executed as post-processing after printing (step S2-7). By the process described above, after receiving an electronic original containing instructions related to printing and finishing of predetermined document data, “unexecutable processes”, which cannot be executed in executing a print job, of processes corresponding to the instructions contained in the electronic original and processes which can be executed in executing the print job are distinguishably presented based on the contents of the electronic original, which makes it possible to enhance the operator's convenience encountered in carrying out printing and finishing processes for production of a single bound book from a plurality of documents. More specifically, when received document data consists of a plurality of files, processes which cause a conflict in execution of a print job are distinguishably presented as “unexecutable processes”, so that operations the user has to carry out as post-processing after printing can be clearly discriminated, which makes it possible to enhance operability and convenience in the printing process.

Then, when the request receiving user depresses a “Print” button 1004 in FIG. 10 to give an instruction for execution of printing (step S2-8), the controller 210 delivers print settings instruction information obtained by executing a conflict check process in the step S2-7 to the default print settings-providing section 206, and instructs the default print settings-providing section 206 to change the default print settings in accordance with the print settings instruction information obtained by the conflict check process (step S2-9). It should be noted that the items not permitted to be set are displayed (presented) on the display section 1015.

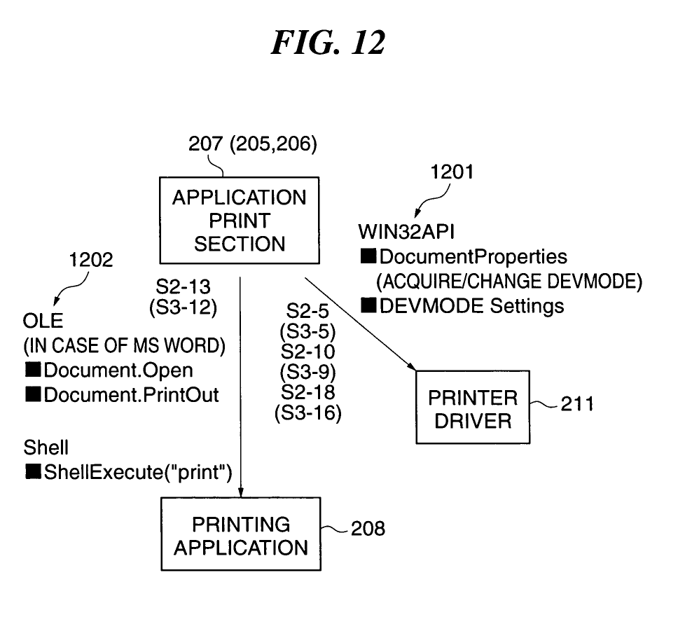

Upon reception of the instruction from the controller 210, the default print settings-providing section 206 changes the default print settings stored in the printer driver 211 (step S2-10). To achieve this process, a method can be envisaged, for example, in which the contents of the DEVMODE structure acquired in the step S2-5 are changed based on the print settings instruction information as shown by the DEVMODE structure 1201 in FIG. 12, and set as the default DEVMODE structure of the printer via the Windows (registered trademark) GDI (Document Properties). Subsequently, the controller 210 acquires the print document data designated in the step S2-1 from the print document data designating and storing section 201 (step S2-11), and issues a print instruction to the application print section 207 (step S2-12).

In response to this print instruction, the application print section 207 starts the printing application 208 and issues a print command to the destination printer (step S2-13).

To achieve this process, as shown by print command information 1202 in FIG. 12, it is possible to employ a method using OLE (Object Linking and Embedding), ActiveX (Internet-related component technology), or the like to issue a print command to an application, a method utilizing a Windows (registered trademark) shell function (“Print” or “PrintTo” is designated as an action), or a method of issuing a print command using an API (Application Program Interface) originally disclosed by each application.

In response to the print command from the controller 210, the printing application 208 converts the print document data e.g. to a GDI drawing command, and instructs the printer driver 211 to perform printing (step S2-14). The printer driver 211 converts the drawing command from the printing application 208 into PDL data and delivers the PDL data to the print data transfer section 209 (step S2-15). When receiving the PDL data, the print data transfer section 209 transfers the same to the destination printer 102 and causes the destination printer 102 to perform printing (step S2-16).

Finally, as post-processing, the controller 210 passes the default print settings information of the destination printer acquired in advance in the step S2-4 to the default print settings-providing section 206 (step S2-17), and restores the default print settings of the destination printer to the state before the start of the printing process (step S2-18).

It is necessary for the default print settings-acquiring section 205, the default print settings-providing section 206, the application print section 207, the printing application 208, and the printer driver 211 to exist on the same computer. However, the print document data designating and storing section 201, the print settings-providing section 202, the print settings-storing section 203, the destination printer designating section 204, the print data transfer section 209, and the controller 210 may or may not exist on the same computer together with the above-mentioned modules.

As described above, according to the present embodiment, in a printing system adapted to receive electronic originals receives a plurality of document data files to be printed, together with designation of a print format and a bookbinding finishing method, it is determined whether received document data is comprised of a plurality of files or a single file, and if the received document data is comprised of a plurality of files, print format and bookbinding finishing setting items that are not permitted to be set in printing each document data file are discriminated and excluded from the designated setting items. Then, the setting items other than the excluded setting items are used as print settings for printing each document data file. This makes it possible to eliminate the inconvenience with the prior art that a finishing process unsuitable for production of a single bound book from a plurality of documents is executed, and to carry out a finishing process suited for production of a single bound book from a plurality of documents.

Further, when a plurality of document data files are received, the print format and bookbinding finishing setting items that are not permitted to be set in printing each document data file, i.e. the excluded setting items are presented to the user, whereby the user is informed of operations to be executed as post-processing by the user himself. This enables the user to clearly discriminate the operations to be executed after completion of the printing, which makes it possible to enhance operability and convenience in the printing process.

Next, a description will be given of a printing system including a print control apparatus according to a second embodiment of the present invention.

As is distinct from the above described first embodiment, the printing system according to the present embodiment is not provided with the print settings conflict database 212. The other elements in the present embodiment are identical to the corresponding ones of the first embodiment (FIGS. 1 to 4, 7 to 9, 11, and 12), and therefore description thereof is omitted. Further, in the present embodiment, a list of unusable functions displayed in the field 1003 in the user interface described with reference to FIG. 10 in the first embodiment is omitted.

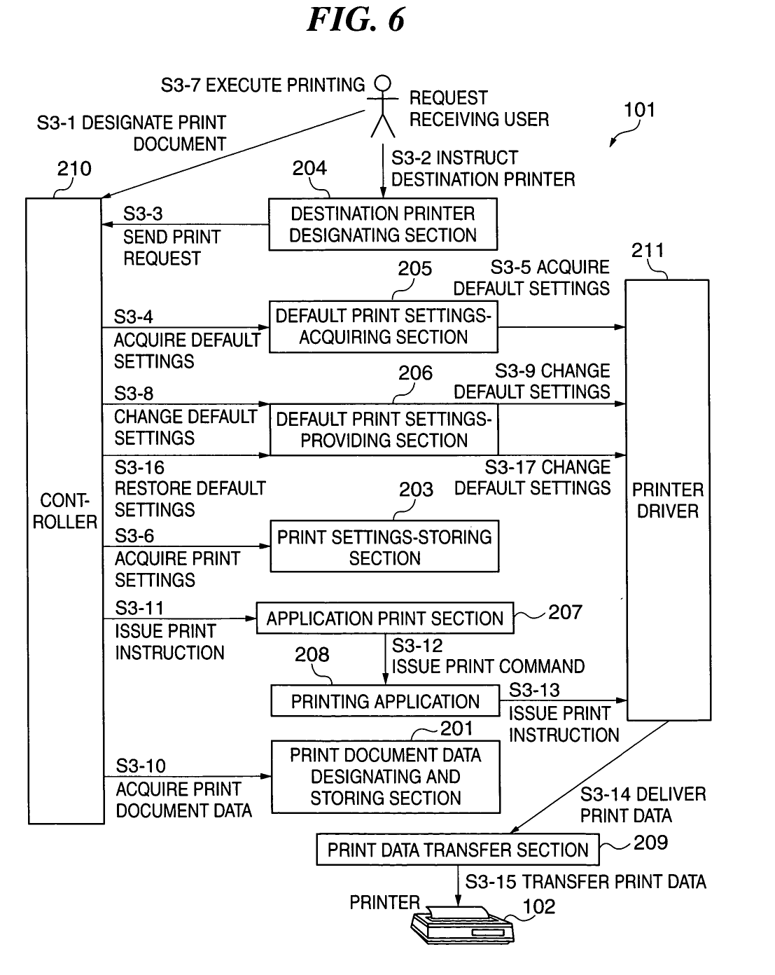

For example, when a finishing setting, such as stapling, is provided for an electronic original comprised of a plurality of document files, and at the same time the files can be synthesized into a single file by the application print section 207, the print settings conflict database 212 in FIG. 5 can be omitted. In this case, the processes shown in a flowchart in FIG. 6 is applied.

Now, a detailed description will be given of the different points from the first embodiment with reference to FIG. 6. Before a print command is issued to the printing application 208 in a step S3-12, a plurality of files acquired in a step S3-10 are synthesized into a single file by the printing application 208, such that instructions (for the print format) contained in the received electronic original are reflected on a print settings-storing part of the synthesized document file.

Then, the print command is issued to the printing application 208 so as to perform printing of the synthesized file.

More specifically, first, the user selects files to be converted into a file in an intermediate file format from a received file name list 901 in the print settings and print document display screen 900 in FIG. 9, using the pointing device. Then, when a “Convert to Intermediate File” button 904 appearing in FIG. 9 is depressed, the controller 210 gives an instruction for file conversion to the application print section 207. The application print section 207 passes parameters, such as the names of the files, to the printing application 208 provided with the converting function, and the selected document files are converted to an intermediate file by the printing application 208. The original document data is stored in the application print section 207, and the file obtained by the conversion is passed to the application print section 207 from the printing application 208 and additionally stored therein. The file name of the intermediate file added at this time can be set freely.

When a “File Printing” button 905 in FIG. 9 is depressed in a state where the newly added intermediate file is selected, the print settings dialog screen 1000 shown in FIG. 10 is opened. After a print instruction is issued via the print settings dialog screen 1000, a process for producing a printed output product, including printing and finishing processes, is executed as in the first embodiment.

As described above, according to the present embodiment, when an electronic original comprised of a plurality of document files is received, the files can be converted into an intermediate file by a simple operation, and at the same time, instructions (print formats) set for the respective document files can be reflected on the intermediate file obtained by the conversion. This makes it possible to prevent a bound book from being prepared in a different form from one desired by a user, e.g. due to unintentional setting of stapling on each document file.

More specifically, in the conventional printing systems that process received electronic originals, when a plurality of documents are received with a print format and a bookbinding finishing method designated, and when printing is performed under all designated print format and bookbinding finishing settings without considering the necessary process for combining the printed output products of the document files into a book, unsuitable printing and finishing processes for preparation of a single bound book can be executed. For example, the bookbinding finishing settings include a stapling setting for stapling the edge of a sheet bundle after completion of printing, but if the stapling setting is performed for each of received documents before printing, every received document is stapled separately after completion of the printing, and hence the original request that all the documents be stapled together cannot be fulfilled. The present embodiment can solve this problem.

On the other hand, in the conventional printing systems adapted to receive electronic originals, a method of designating a single file in response to a single print request from a print requesting user has been generally employed. However, a flexible original receiving method is desired which allows the user to designate covers and text as separate files in a single print request. According to the present embodiment, when a print request is made for printing an electronic original comprised of a plurality of files, print settings which can be applied to the individual files and print settings which cannot be uniformly applied to some of the files can be separately presented to the operator, whereby it is possible to prevent erroneous execution of file-by-file stapling processing in a printing process, thus enabling proper handling of the received request for printing the files.

Although in the above description of the first and second embodiments, the bookbinding finishing method has not been referred to, it is not limited to a specific one, but the present invention is applicable to various bookbinding methods, including stapling.

Further, although in the first and second embodiments described above, the printer 102 is implemented by a page printer, this is not limitative, but the present invention is applicable to the case where a printer of another type than the page printer is used.

Furthermore, although in the first and second embodiments, the printer 102 is employed as a printing apparatus, this is not limitative, but the printing apparatus may be implemented by a copying machine equipped with a printer function or a multi-function machine equipped with the printer function.

It is to be understood that the object of the present invention may also be accomplished by supplying a system or an apparatus with a storage medium (or a recording medium) in which a program code (flowcharts in FIGS. 4, 5 and 6) of software, which realizes the functions of either of the above described embodiments is stored, and causing a computer (or CPU or MPU) of the system or apparatus to read out and execute the program code stored in the storage medium.

In this case, the program code itself read from the storage medium realizes the functions of either of the above described embodiments, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network from another computer, a database, or the like, not shown, connected to the Internet, a commercial network, a local area network, or the like.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing the program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

Further, the above program has only to realize the functions of either of the above described embodiments on a computer, and the form of the program may be an object code, a program code executed by an interpreter, or script data supplied to an OS.

In this case, the program code may be supplied directly from a storage medium on which the program code is stored, or from a computer, database, or the like, not shown, that is connected via the Internet, a commercial network, a local area network, or the like.

Although in the above described embodiment, the electrophotographic printing is adopted as the printing method executed by the complex apparatus, there is no intention to limit the invention to this. For example, the present invention may be applied to a variety of printing methods such as ink-jet printing, thermal transfer, thermal printing, electrostatic printing, and discharge breakdown printing.

The form of the program may be an object code, a program code executed by an interpreter, or script data supplied to an OS (Operating System).

### CROSS REFERENCE TO RELATED APPLICATION

This application claims priority from Japanese Patent Application No. 2004-011229 filed Jan. 19, 2004, which is hereby incorporated by reference herein.

1. A print control apparatus that supplies a print job to a printing apparatus capable of performing finishing processing on a printed output product, comprising:
an original receiving device that receives an electronic original containing instructions related to printing and finishing of predetermined document data; and
a presenting device that distinguishably presents processes which are unexecutable in executing the print job and processes which are executable, from among processes corresponding to the instructions contained in the electronic original, based on contents of the electronic original.

2. A print control apparatus as claimed in claim 1, wherein said presenting device is operable when the electronic original comprises a plurality of document data files, to distinguishably present the processes which are unexecutable in executing the print job, from among the processes corresponding to the instructions contained in the electronic original.

3. A print control apparatus that supplies a print job to a printing apparatus capable of performing finishing processing on a printed output product, comprising:
an original receiving device that receives an electronic original containing instructions related to printing and finishing of predetermined document data;
a determination device that is operable when the electronic original received by said original receiving device comprises a plurality of document data files, to determine which of setting items related to processes which are not permitted to be set in printing each of the document data files, from among setting items related to processes corresponding to the instructions contained in the electronic original;
a changing device that changes default print settings of the printing apparatus to settings matching setting items obtained by excluding the setting items determined not permitted to be set from the setting items related to the processes corresponding to the instructions contained in the electronic original; and
an issuing device that issues the print job in accordance with the print settings changed by said changing device.

4. A print control apparatus as claimed in claim 3, wherein the setting items related to the processes corresponding to the instructions contained in the electronic original are for setting a print format in which the document data is printed on a printing medium and a book finishing method applied in executing a bookbinding process after printing.

5. A print control apparatus as claimed in claim 3, comprising a storage device that retrievably stores the setting items not permitted to be set, and a presenting device that presents the setting items not permitted to be set.

6. A method of controlling a print control apparatus that supplies a print job to a printing apparatus capable of performing finishing processing on a printed output product, comprising:
an original receiving step of receiving an electronic original containing instructions related to printing and finishing of predetermined document data; and
a presenting step of distinguishably presenting processes which are unexecutable in executing the print job and processes which are executable, from among processes corresponding to the instructions contained in the electronic original, based on contents of the electronic original.

7. A method as claimed in claim 6, wherein when the electronic original comprises a plurality of document data files, in said presenting step, the processes which are unexecutable in executing the print job are distinguishably presented, from among the processes corresponding to the instructions contained in the electronic original.

8. A method of controlling a print control apparatus that supplies a print job to a printing apparatus capable of performing finishing processing on a printed output product, comprising:
an original receiving step of receiving an electronic original containing instructions related to printing and finishing of predetermined document data;
a determination step of determining which of setting items related to processes which are not permitted to be set in printing each of a plurality of document data files, from among setting items related to processes corresponding to the instructions contained in the electronic original, when the electronic original received in said original receiving step comprises the plurality of document data files;
a changing step of changing default print settings of the printing apparatus to settings matching setting items obtained by excluding the setting items determined not permitted to be set from the setting items related to the processes corresponding to the instructions contained in the electronic original; and
an issuing step of issuing the print job in accordance with the print settings changed in said changing step.

9. A method as claimed in claim 8, wherein the setting items related to the processes corresponding to the instructions contained in the electronic original are for setting a print format in which the document data is printed on a printing medium and a book finishing method applied in executing a bookbinding process after printing.

10. A method as claimed in claim 8, comprising a storage step of retrievably storing the setting items not permitted to be set, and a presenting step of presenting the setting items not permitted to be set.

11. A program for causing a computer to execute a method of controlling a print control apparatus that supplies a print job to a printing apparatus capable of performing finishing processing on a printed output product, comprising:
an original receiving module for receiving an electronic original containing instructions related to printing and finishing of predetermined document data; and
a presenting module for distinguishably presenting processes which are unexecutable in executing the print job and processes which are executable, from among processes corresponding to the instructions contained in the electronic original, based on contents of the electronic original.

12. A program as claimed in claim 11, wherein when the electronic original comprises a plurality of document data files, said presenting distinguishably presents the processes which are unexecutable in executing the print job, from among the processes corresponding to the instructions contained in the electronic original.

13. A program for causing a computer to execute a method of controlling a print control apparatus that supplies a print job to a printing apparatus capable of performing finishing processing on a printed output product, comprising:
an original receiving module for receiving an electronic original containing instructions related to printing and finishing of predetermined document data;
a determination module for determining which of setting items related to processes which are not permitted to be set in printing each of a plurality of document data files, from among setting items related to processes corresponding to the instructions contained in the electronic original, when the electronic original received by said original receiving module comprises the plurality of document data files;
a changing module for changing default print settings of the printing apparatus to settings matching setting items obtained by excluding the setting items determined not permitted to be set from the setting items related to the processes corresponding to the instructions contained in the electronic original; and
an issuing module for issuing the print job in accordance with the print settings changed by said changing module.

14. A program as claimed in claim 13, wherein the setting items related to the processes corresponding to the instructions contained in the electronic original are for setting a print format in which the document data is printed on a printing medium and a book finishing method applied in executing a bookbinding process after printing.

15. A program as claimed in claim 13, comprising a storage module for retrievably storing the setting items not permitted to be set, and a presenting module for presenting the setting items not permitted to be set.
